(19) United States
(12) Patent Application Publication
(10) Pub. No.: US 2015/0046562 A1
(43) Pub. Date: Feb. 12, 2015

(54) WEB BROWSER ORCHESTRATION

(71) Applicant: Convergent Development Limited, Woodstock (GB)

(72) Inventor: Peter B. Malcolm, Woodstock (GB)

(21) Appl. No.: 14/284,018

(22) Filed: May 21, 2014

Related U.S. Application Data
(60) Provisional application No. 61/863,333, filed on Aug. 7, 2013.

(51) Int. Cl. G06F 17/30; G06F 3/0484; H04L 29/08

(52) U.S. Cl. CPC G06F 17/30873; G06F 17/30882; H04L 67/02; G06F 3/0484
USPC 709/217; 715/760; 715/205

(57) ABSTRACT

The invention relates to enabling one or more users or applications to orchestrate, through direct or indirect communications between Web browser instances, the operation of multiple of the Web browser instances, and/or pages of the same Web browser instance, thereby enhancing user experience and functionality. The invention thus provides for interacting with a computer generated webpage. In a particular embodiment, the method defines a centrally managed target set account on a target set server, and logging-in to the target set account from each device to be included the target set. An entry is created for each such logged-in device and each entry includes at least an identifier for each device and connection information for each device. Using the target set server, the information stored in the entries in the target set can be enabled as interactive displays on each of the devices identified in the target set entries.

### CROSS-REFERENCE TO RELATED APPLICATIONS

This application claims priority from U.S. provisional application Ser. No. 61/863,333, filed on Aug. 7, 2013, which is incorporated herein, in its entirety, by reference

### BACKGROUND OF THE INVENTION

The World Wide Web (abbreviated as www) and commonly known as the Web, is a system of interlinked hypertext documents accessed via the Internet. Standards for the operation of the World Wide Web are published by the World Wide Web Consortium.

Users access documents held on Web servers using a client application known as a Web browser which retrieves, using hypertext transfer protocol (HTTP), documents written in hypertext mark-up language (HTML) and then displays them. The displayed document is usually described as a Web page, and may contain text, images, videos and other multimedia, as well as computer programs which run in isolation in the Web browser to perform functions such as updating the displayed Web page with live data. Well known Web browsers used on personal computers include Microsoft Internet Explorer, Mozilla Firefox, Google Chrome and Apple's Safari. Web browsers are also embedded into many other electronic devices including smartphones and tablets. Well known Web page programming languages that run in the Web browser include JavaScript and jQuery.

Users access Web pages through a character string known as a Uniform Resource Locator (URL). Each page on the Web has a unique URL to identify and access it. URLs may be typed in by the user, stored as bookmarks, or embedded into other applications, documents or Web pages when they are known as hyperlinks. A hyperlink may be visible as the full URL, or may be referenced by another visible object, such as informative text, or a graphic. Moving the computer mouse pointer over a hyperlink, or its associated text or graphic, and clicking the mouse button causes the Web browser to “navigate” to the requested page, by retrieving the hypertext document (identified by the URL) from the appropriate Web server, and replacing the currently displayed page with the newly retrieved one.

Users operate Web browsers by navigating to a first Web page, either by typing in its URL, or more often automatically via a saved URL when the browser application is started. Thereafter, operation of the browser is primarily via hyperlinks, until the user decides to specify a new starting point, when they may type in a new URL or navigate to a saved one.

In some instances, users will find it desirable to retain the current page, rather than having it overwritten by the new page, and for this purpose Web browsers typically provide for opening an additional page within the same browser application, or to start another browser application instance on which the page is then displayed. Where multiple pages are opened in a single browser instance, each is placed on a different “tab” with only one tab usually visible at any given time, but providing easy means to instantly switch between them without re-loading the displayed page. For example, the Microsoft Internet Explorer Web browser allows the user to “right-click” on a hyperlink which displays a context menu with “Open in a new tab” and “Open in a new window” options.

Web browsers also have the ability to save metadata, manually or automatically, such as the user's “favorite” pages, bookmarks, a history of retrieved pages, or usernames and passwords that may be required to access some Web pages.

In addition, Web servers can cause the browser application to store a small amount of data, known as a “cookie” on the user's machine. This data persists on the user's machine (unless the user intentionally deletes it) and is available to the Web server whenever the user retrieves documents from that server in the future. Web servers use cookies to identify users, for example to prevent them from having to repeatedly enter login credentials, and to “remember” other details of that user's past activity. The cookies for a given Web server are stored in the same place on the user's machine, and thus all browser instances (and tabs within a browser instance) will access the same cookies for any given site. This is beneficial to the user as, for example, if the user's logged in status is stored in a cookie, the user need not be forced to authenticate again if they open pages in new tabs or browser instances.

Other than in the limited cases described above, Web browsers (and tabs within a browser instance) operate in complete isolation, with the user operating on only one at any given time.

User actions carried out in one browser or tab have no effect on the operation of any other browser or tab.

For the purposes of this document, the screen area on which Web pages are displayed will be termed a “target”. Each Web browser instance will have at least one target, and may have many, each accessed through a different tab. As noted above, only one tab is usually visible at any given time.

In addition, it should be noted that Web pages have the ability to be split into one or more segments each known as a “frame”. Each frame can display a different hypertext document, and thus each can be considered a target.

Web browsers typically provide a methodology for their functionality to be extended by a “browser extension” (also known as a “plug-in”, “add-on” or “browser helper object”). Browser extensions can be developed by third parties and are frequently used to provide specialist toolbars, easy access to search engines, and other similar functions.

Historically, users typically had a single computer screen on which they operated at any given time, although there were notable exceptions, such as in financial dealing rooms where users often had multiple computers and screens each showing different information. More recently, having dual screens on a single computer has become commonplace, and with the advent of smartphones and tablet computers, users often have multiple devices, each with one or more Web browsers. All of these Web browsers operate in isolation.

### SUMMARY OF THE INVENTION

The present invention provides a method and apparatus for targets, Web browser applications and displayed user generated pages, to inter-operate, either under the direction of the user, or as determined by a given Web site. A simple example would be clicking a hyperlink in one target (the “source target”) which causes the navigation to occur on an entirely different target (the “destination target”). The destination target could be within a frame, on another tab, in the same or another browser instance on the same computer or device, or on a different computer or device in the same, or an entirely different physical location.

A method according to the invention, relates to operating a plurality of web browser applications in communication with each other, each of the web browser applications displaying at least one computer generated target web page. The method features communicating, between a communication source which can include either or both of a first target web page and its first web browser application, to one or more other of said target web pages, and causing an action on the first target web page to affect the occurrence of web page navigation at at least one of the other target web pages.

The method can further feature communicating directly or indirectly between one of the other target web pages and the browser application hosting the first target web page. The method further can communicate directly or indirectly between ones of the target web pages.

In one exemplary embodiment, the user defines a “target set” identifying the available destination targets on which navigation can occur. In this embodiment, the target set is managed centrally, such that each Web target (or the Web browser hosting it) can be aware of the existence of other targets in the target set, and their availability.

When navigation on another target is to occur, the source target (or the Web browser hosting it) sends a navigation request to the destination target (or the Web browser hosting it) using one of a number of possible methods. The destination target (or Web browser) then carries out the navigation request.

The destination target can be determined manually by the user of the source target, or programmatically at the Web server which generates the hypertext document (Web page) displayed on the source target, by code embedded into the hypertext document (Web page) displayed on the source target, by browser extension code on the Web browser hosting the source target, or by any combination of these.

Optionally, the user can elect to create a new destination target, either as a tab in an existing Web browser instance, or by launching a new Web browser instance on a given device.

The invention need not be limited to causing navigation to occur on a single destination target; it could occur on any selection of targets in the set, including the source target.

In addition, the invention can be used to repeat the last navigation to occur on the source target, such that the currently displayed hypertext document (Web page) on the source target is navigated to and displayed on the destination target(s).

Optionally, the above techniques can be combined, for example to create a new set of tabs as destination targets, each of which repeats the last navigation to occur on a corresponding set of source tabs.

Optionally, also, a user, and targets on his/her devices, can be members of more than one target set. An apparatus and method are provided for the user to select which target set, and hence which destination targets, is operational at any given time. Where multiple users “share” a target set, any user is allowed to determine when they wish to be open to accepting navigation requests from another user's device.

The invention has a broad variety of use cases, examples of which will be given hereinafter, but it will be appreciated that there are many more such cases which can be created.

Consider a user working on his or her office PC, researching information on the Web. The user wants to continue the research on their home PC, or while travelling using their laptop, smartphone or tablet. Without the invention, the user has to re-type the URL of each tab on their Web browser(s) into corresponding tabs on the new device, or perform a cumbersome “cut and paste” sequence via email or instant messaging. Both methods are time consuming and error prone. In accordance with an exemplary embodiment of the invention, the user can issue a simple “one-click” command which replicates all the currently displayed Web pages on one device to another device of their choice.

A similar situation frequently occurs when two users are engaged in live communication, such as a telephone call. User A has browsed to a given Web page on their device, and wants User B to view the same page on his/her device. Without the invention, user A has to read the URL to user B, or “cut and paste” it into an email or chat session, which user B then retrieves to “cut and paste” into their own application. With the invention the two users can be members of the same target set, and replicate pages on each other's devices with a “oneclick” command. The users can set up a target set for communication between them, and only allow the set to be “active” when they are in live communication with one another.

Consider a classroom environment (physical or virtual) in which students each have their own device. The invention allows the teacher to immediately guide students to any given Web page (or set of pages) either for information, or to define a starting point from which the students then navigate. Without the invention, the teacher is limited to solutions which mimic the teacher's screen display on the student's machine, and which do not allow students to continue navigation themselves.

Consider a monitoring situation, such as a network operations center, where multiple secondary displays (typically attached to different computers) are located adjacent to one or more primary displays. Operators typically view alerts on a central (primary) display, and use secondary displays, or completely separate computers, to investigate them, thereby leaving the central (primary) display(s) to show further alerts. Without the invention, precious time is lost, and potential errors made while the investigating user locates the source of the alert. With the invention, a user can simply click a hyperlink on the central (primary) display which immediately navigates to the source of the alert on the required secondary, or separate computer.

Consider an application that needs to present a large amount of information simultaneously to one or more users. Current high definition screen display resolution is typically 1920 by 1080 pixels, and while higher resolution display screens exist, they require more advanced graphics cards to drive them, and are considerably more expensive. Using the invention, applications can seamlessly operate across multiple screen displays inexpensively and with ease.

### BRIEF DESCRIPTION OF THE FIGURES

Other objects and features of the invention will be apparent from the drawings in which:

FIG. 1 shows a variety of devices running Web browser instances connected via the Internet to a Web server;

FIG. 2 shows an example of a centrally held target set definition in table form.

FIG. 3 shows a sample Web browser displaying a hypertext document (Web page) retrieved from a Web server;

FIG. 4 shows a sample Web browser with context menu options to allow navigation to a different target browser;

FIG. 5 shows a sample Web browser where a set of buttons allows the user to select the destination target for subsequent hyperlink navigation;

FIG. 6 shows the message flow between components when the user initiates hyperlink navigation on a different device;

FIG. 7 shows a sample Web page incorporating a drop-down field which allows the user to select the destination target for the next hyperlink navigation;

FIGS. 8A and 8B are operational flow diagrams of an exemplary embodiment of the invention; and

FIG. 9 is an operational flow diagram continuing from FIGS. 8A and 8B.

### DETAILED DESCRIPTION OF EXEMPLARY EMBODIMENTS

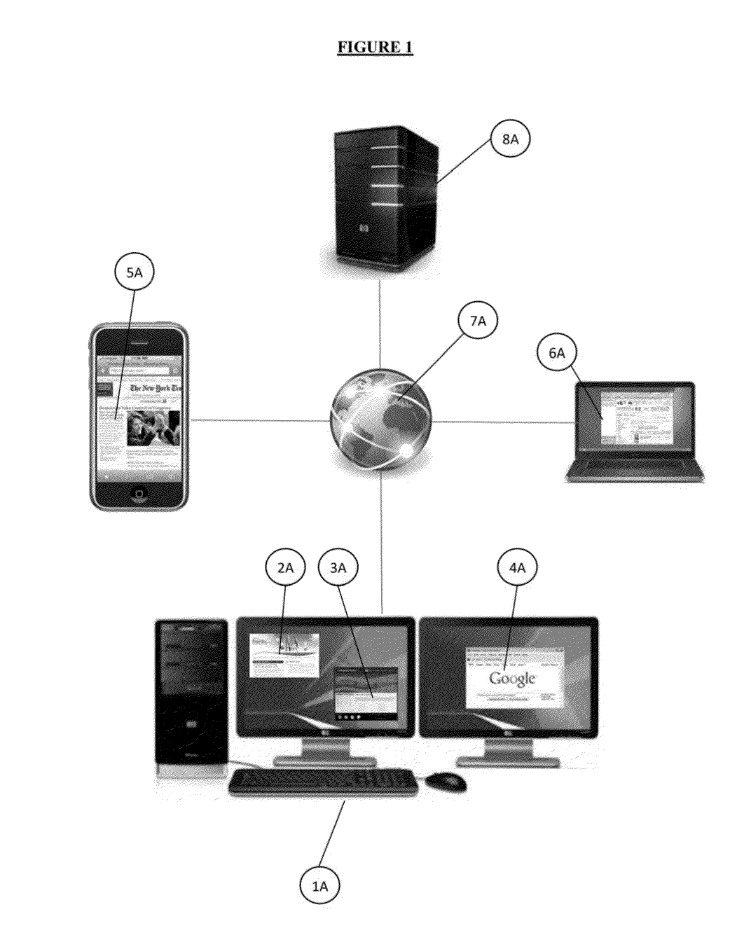

Referring to FIG. 1, in one exemplary embodiment, a computer workstation 1A, which has two screen displays attached, is running three instances of a Web browser application. Two instances, 2A and 3A, appear on the first display, and the third instance 4A appears on the second display. The user also has a smartphone 5A, and a home laptop computer 6A, each running Web browser application instances. Each of the Web browser instances is connected via the Internet 7A to one or more Web servers 8A.

The user has defined a centrally managed target set, preferably by creating a user account on a Web server intended for the purpose (the “target set server”). The user logs-in to the target set server account from each device he or she wishes to have targets in the target set, and creates an entry for each target.

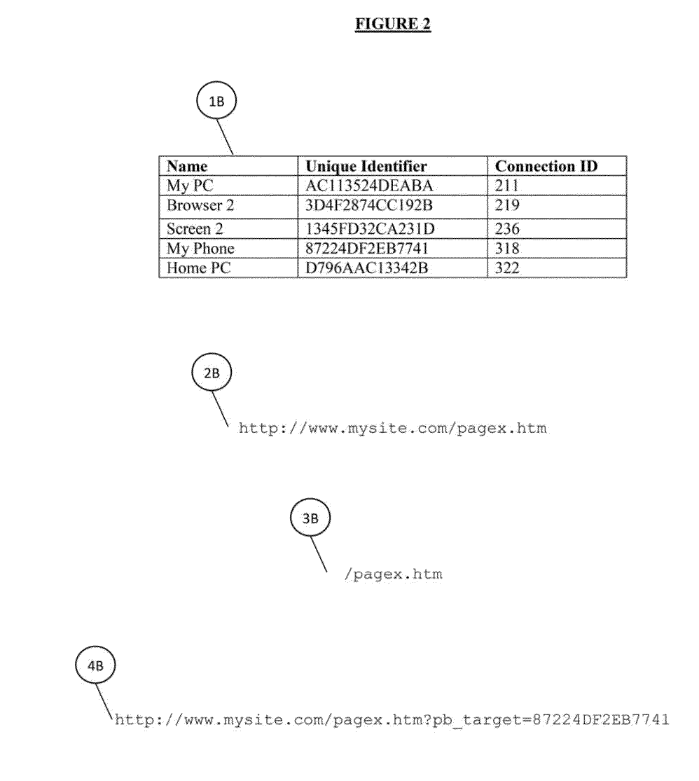

Referring to FIG. 2, table 1B shows a target set with 5 target entries. The user gives each target entry a suitable name to permit easy recognition. In this case the table entry names refer to Web browser instances 2A, 3A, 4A, 5A and 6A respectively.

The target set server creates a unique identifier for each target, which the Web browser stores on the local device, preferably in the form of a cookie. Where there is more than one target on a given device, a separate cookie is stored for each, in such a way that each target is uniquely identifiable.

The target set server also maintains connection information for each connected target, such that it can communicate with that target. Each entry in table 1B provides a connection ID identifying the communication channel established between the target set server and the Web browser instance on which the target is running.

A given Web browser or target can now communicate, or otherwise interrogate, the target set server to establish the names and identities of other targets in the set. It simply passes its unique identifier to the target set server, which uses the unique identifier to establish which set the target is a member of, and returns a list of names and identifiers for other targets in the set. If unique identifiers are allocated randomly by the target set server, and are of sufficient length, it will be unfeasible for any unauthorized third party to guess them. It will be appreciated that additional security procedures and mechanisms could be provided, but they will not be discussed further here.

With knowledge of the full target set, each target can now present options to the user, or programmatically determine which target should be used for each navigation request.

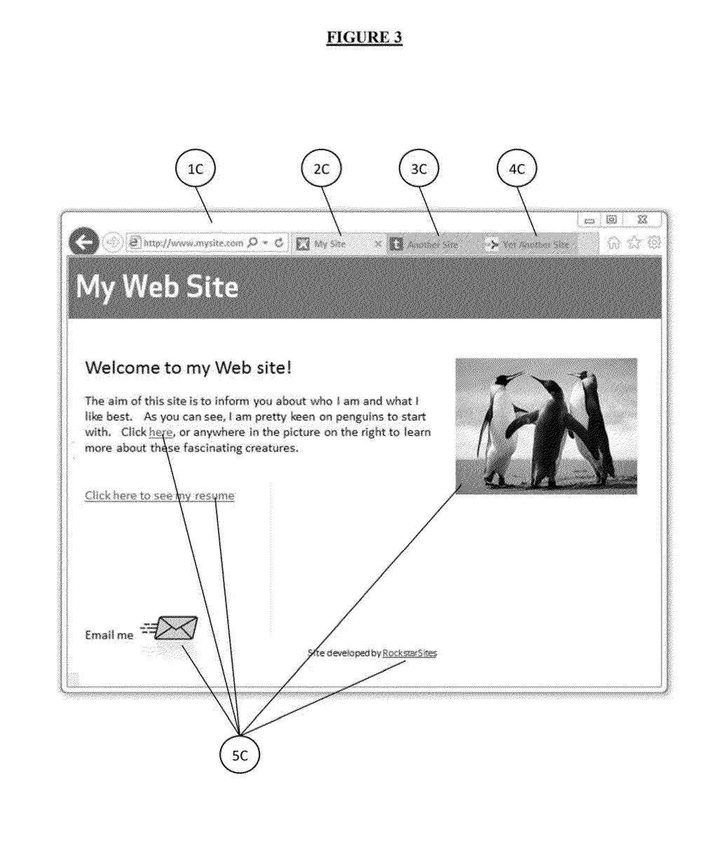

Referring to FIG. 3, an exemplary Web browser 1C has three tabs, 2C, 3C and 4C. Tab 2C is visible, the others being currently hidden. The sample Web page contains informative text and graphics. The Web page contains a variety of hyperlinks 5C associated with highlighted text or graphic elements. Each hyperlink references a URL, typically in the example form 2B, or in an example relative form to the current page 3B.

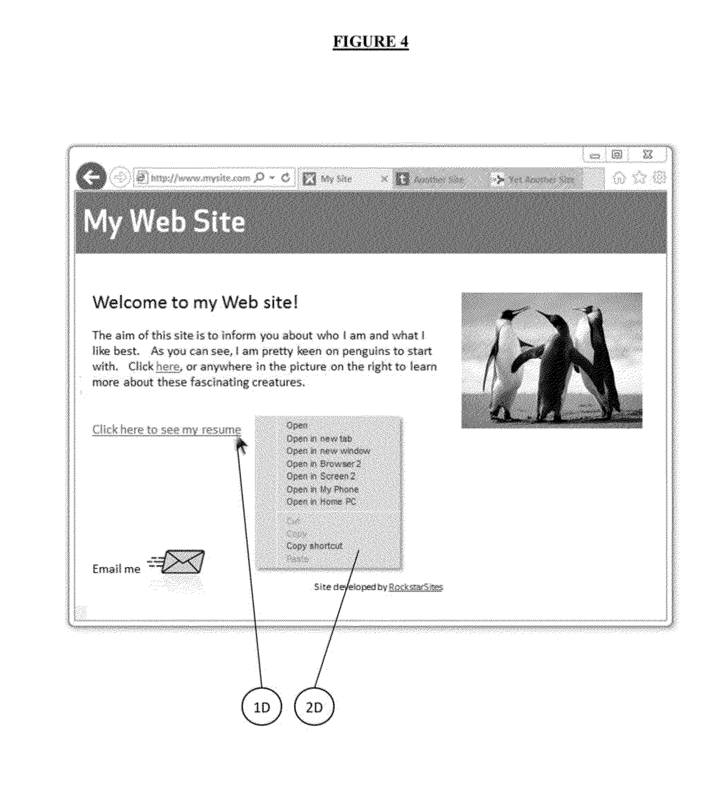

Referring to FIG. 4, a hyperlink 1D on which the user has performed a “right click” mouse operation causes a context menu 2D to appear. Context menus of this type are standard in Microsoft Windows environments, however the context menu has been extended (either by a browser extension, or by adding the functionality to the browser itself) to include options to open the hyperlink (that is to navigate to it) in four possible targets, being the names of four members of target set. The fifth member of the set (the first in table 1B) is excluded since it is the target upon which the user is operating and would be equivalent to the first “Open” option shown in the context menu.

If the user elects to open the hyperlink on one of the listed targets, then a message is sent, directly or indirectly, to the target (or the Web browser hosting the target) to cause the navigation to occur.

There are a wide variety of methods of sending, receiving and acting upon the message, several of which will now be discussed.

If the Web browsers are directly connected, for example on the same local area network (LAN), then they may communicate directly using a variety of standard network protocols. In such cases, the connection ID in table 1B could be replaced by the address of the device running the relevant Web browser.

Preferably, the devices will be connected through a wide area network, such as the Internet. However, in the majority of cases, client devices will be behind a firewall employing network address translation (NAT) for security purposes, and thereby preventing direct communication between client devices.

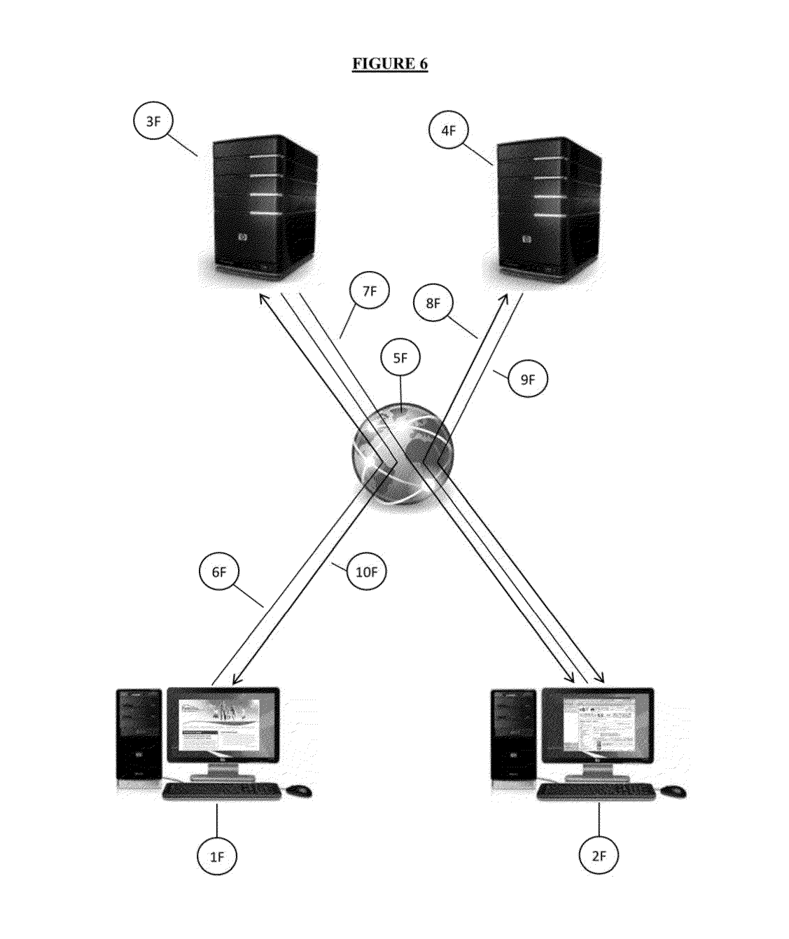

In one variant of the invention, the target set server is used to facilitate such communication since it has connections established with each target device and can thus enable in direct communications between the web browsers. FIG. 6 illustrates a source target running on device 1F, a destination target running on device 2F, a target set server 3F, and a standard Web server 4F, all connected through the Internet 5F. When the user requests to open a hyperlink (Web page) on the destination target, the source target sends a message 6F to the target set server 3F detailing the unique identifier of the target that is to carry out the navigation request, and the URL to which it is to navigate. The target set server 3F verifies that the source and destination targets are members of the same target set, and then sends the message 7F to the target using the connection identifier associated with that target in table 1B.

The message is received by the Web browser hosting the intended target (either by a browser extension, or by adding the functionality to the browser itself), or by program code in the hypertext document (Web page) currently displayed in the target on device 2F. In either case, the receiving program code then causes the target to navigate to the requested URL with a normal request to the standard Web server 4F, which replies with the requested hypertext document 9F. Optionally, the target set server 3F can acknowledge that the request 7F was successfully sent by sending an acknowledgment message 10F back to the source target 1F.

Optionally, messages 6F and 7F could include flags to indicate if navigation should occur in the current target, or in a new target, either as a new tab or in a new Browser instance. If so, options could also be provided to automatically add the new target to the target set. When the user first adds a target to the target set, they could also be provided with an option to force navigation requests from another target to always occur in a new target, ensuring no current hypertext document (Web page) is overwritten.

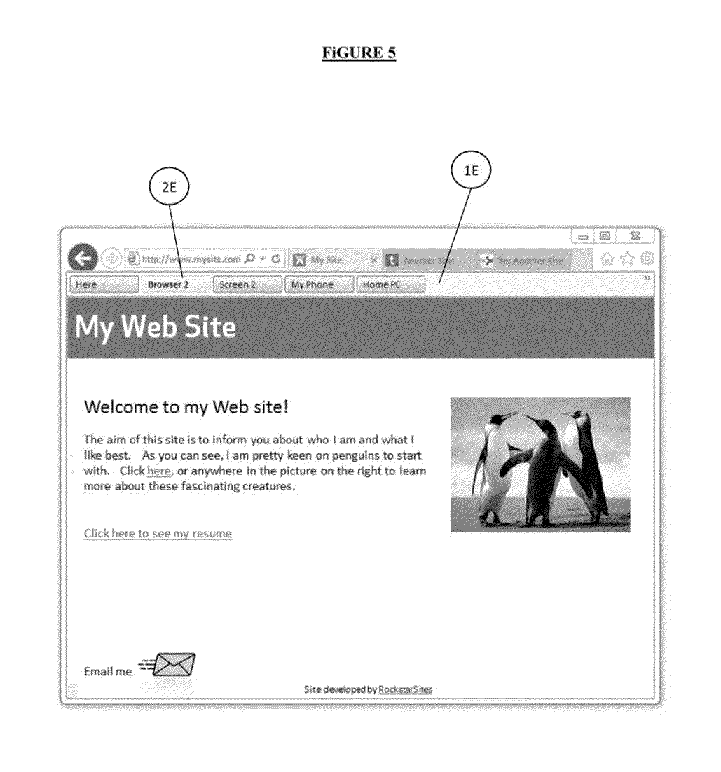

Referring to FIG. 5, a toolbar 1E has been added to the Web browser (either by a browser extension, or by adding the functionality to the browser itself). The toolbar contains a set of buttons which allow the user to determine the target to be used when opening (that is navigating to) hyperlinks. In this example, the second button 2E has been clicked, and will remain in the “down” (selected) state until the user clicks a different button. Thus all navigation will occur in the Web browser 3A (named “Browser 2”). The first button 3E is labeled “Here”, and if clicked will cause navigation to occur as normal in that browser.

Note that with the toolbar, the usual context menu options “Open”, “Open in a new tab” and “Open in a new window” can be applied to the selected destination target by including an appropriate flag in the message sent to destination target.

A variety of additional functions can be provided to the user in a toolbar or elsewhere, for example a single “Copy All” button could cause the Web page displayed on each tab of the current Web browser to be navigated to on a set of new tabs on the destination's Web browser. When the button is clicked, the Web browser cycles through each current tab, sending a navigation request for each to the currently selected target. In each case, the requested URL will be the current address of the displayed page, rather than a hyperlink contained within it.

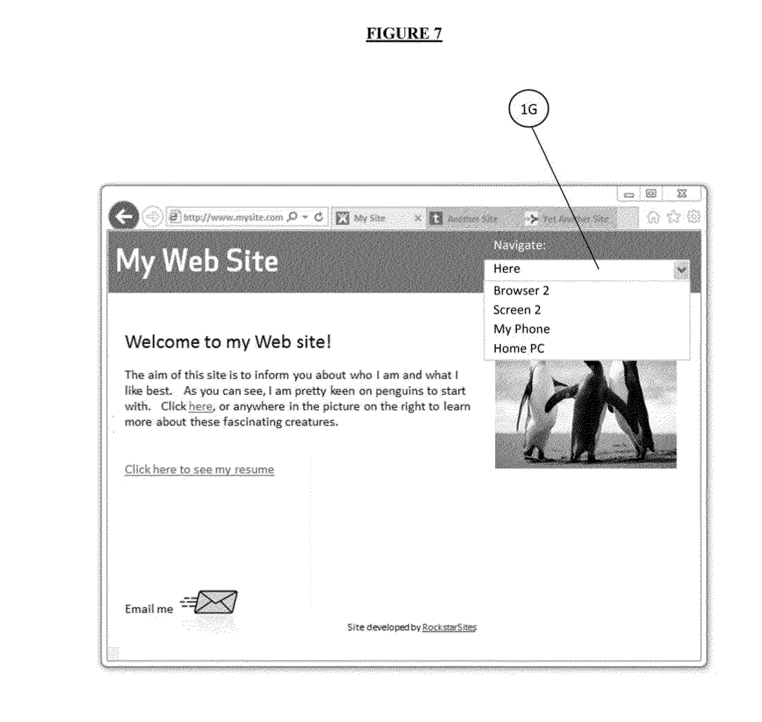

In an alternate variant of the invention, the destination target can be determined without requiring any modification or extension of the source Web browser. This is possible where a Web based application wants to provide the capabilities of the invention, by including program code in one or more of the hypertext documents (Web pages) generated by that application. For example, in FIG. 7, the displayed Web page includes a drop-down 1G which allows the user to select from available targets. When the user clicks any of the hyperlinks on the page, program code in the hypertext document intercepts the request and sends it to the selected destination target as described in connection with FIG. 6. It is particularly advantageous if the target set server and the application's Web server are integrated, so that the drop-down can be populated, by methods known in the field, prior to being sent to a client device. The destination target can also be determined programmatically, rather than being set by the user.

In a further variant of the invention, the destination target is determined by the URLs associated with each hyperlink in the hypertext document (Web page), without requiring any modification or extension of the source Web browser, or any program code in the hypertext document. In FIG. 2, URL 4B includes the destination target's unique identifier as a parameter. When the user clicks on the hyperlink, the standard HTTP request is sent to the Web server. Program code in the Web server identifies the existence of the “pb_target” variable as in URL 4B, from which it determines that the request is intended to be processed by the destination target identified by the value assigned to the “pb_target” variable—in this case the unique identifier associated in table 1B with “My Phone”. The Web server then checks the unique identifier, strips the “pb_target” parameter from the URL and sends the navigation request message to the destination target as previously explained. An important additional requirement is for the Web server to respond to the Web browser making the HTTP request. Normally the Web server would respond with an HTTP “200 OK” header, indicating it had found the required page, and would commence downloading it for the Web browser to start displaying. However, in this case we explicitly do not want the navigation to occur in that browser, and so the Web server responds with an HTTP “204 No Content” header which indicates no action is required by the Web browser which leaves the existing page displayed. If the Web server were to determine that the specified unique identifier did not exist, or the destination target was not available, it could return an HTTP error message, such as HTTP “503 Service Unavailable”.

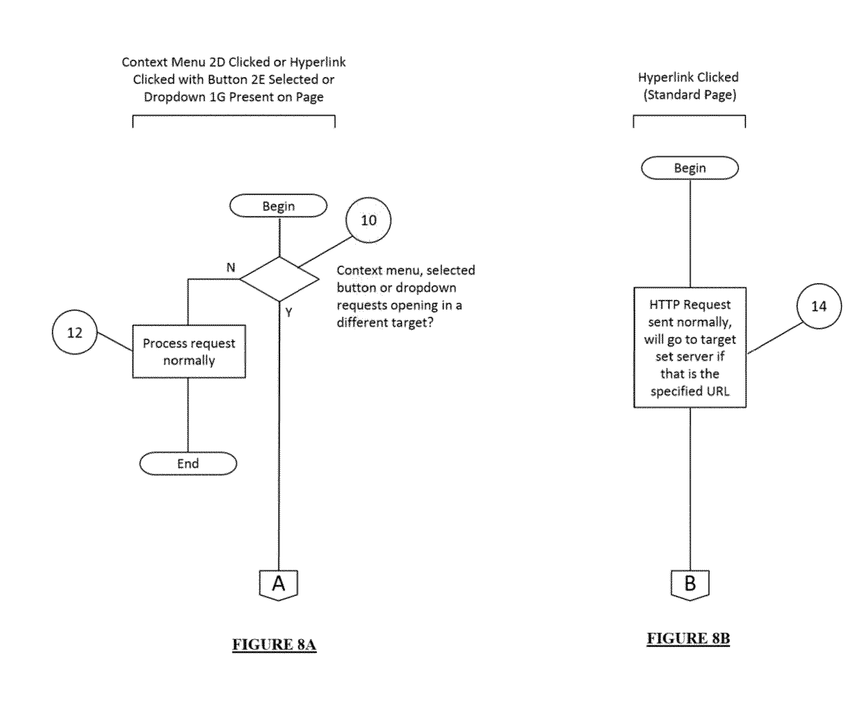

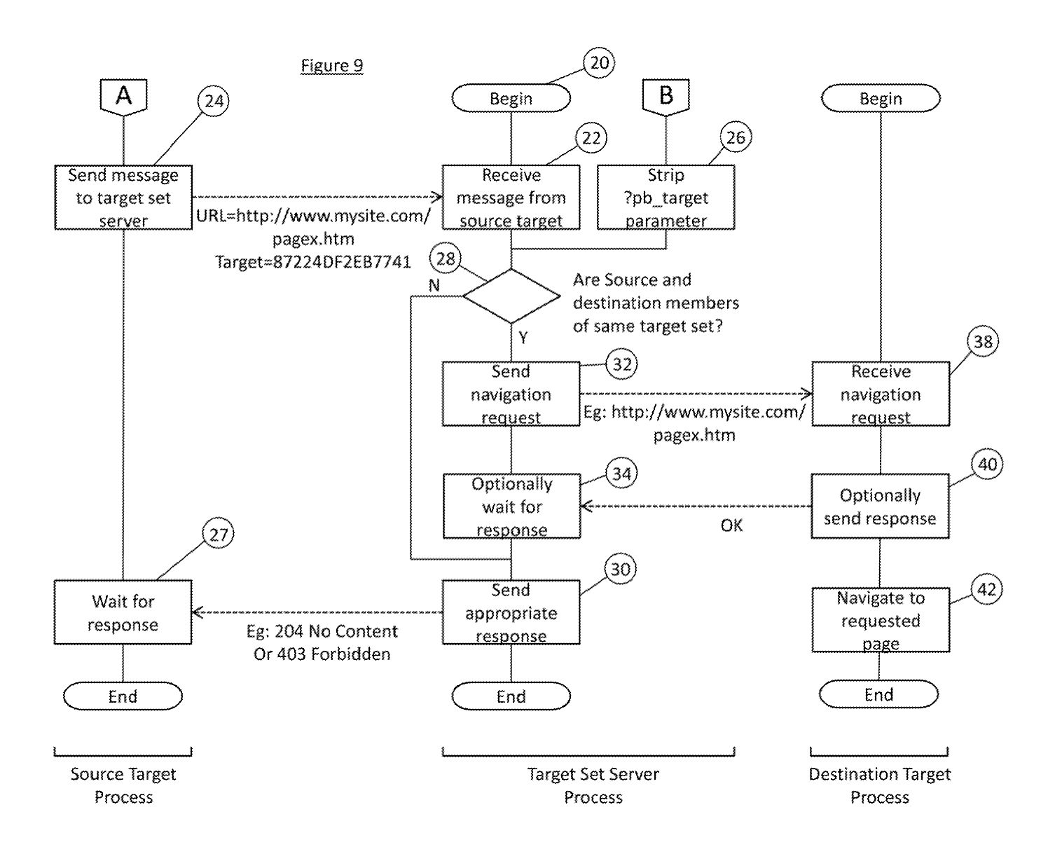

Referring now to the illustrative operational flow diagrams of FIGS. 8A, 8B, and 9, the context menu 2D illustrated in FIG. 4 can be clicked upon, or the hyperlink illustrated in FIG. 5 at button 2E can be selected or the drop down menu 1G of FIG. 7 can be used to present/target the destination of the page being requested. The methodology is illustrated in FIG. 8A.

A selected button or drop-down request is tested at 10 to determine if either has been selected to request opening in a different target. If it has not been requested, the process continues normally at 12. Otherwise, it continues to “A” in FIG. 9. On the other hand, if the hyperlink of a standard page has been clicked upon, referring to FIG. 8B, the system, at 14, sends the request normally to the target set server that is the specified URL. The system then proceeds to “B” in FIG. 9.

Referring to FIG. 9, the system begins at 20 and first checks for reception of a message from the source target. This occurs at 22. If the message resulted from a selected button or drop-down request, in the source target process, for opening the requested page in a different target, the message is sent at 24 to the target set server process. The source target process then waits for a response from the target set server process at 27. In the meantime, the URL if, that was the source of the instruction, is sent to the message receive element 22 of the target set server process.

If, on the other hand, the message is from a clicked hyperlink, the target parameters are stripped, at 26, from the specified URL and the source and destination members are checked, at 28, to see if they are from the same target set. If they are not, the system passes to element 30 where an appropriate message is sent indicating that the requested activity is forbidden. On the other hand, if the source and destination members are in the same target set, then a navigation request is sent at 32 and, optionally, the system can wait for a response at 34. In parallel with this activity, the system also begins a thread wherein the navigation request from 32 is received at 38 of the destination target process, and a response is optionally sent back to the target set server at 40. Once received at the target set server 34, the appropriate response is sent at 30 to the source target process 27. Thereafter, the destination target process navigates, at 42, to the requested page.

Other embodiments of the invention will be apparent to one of skill in the field and are within the scope of the following claims.

What is claimed is:

1. A method for operating at least one web browser application, collectively displaying at least two computer generated target web pages, comprising
communicating between a communication source comprising at least one of a first target web page and its first web browser application, to at least one other of said target web pages; and
causing an action on said first target web page to affect the occurrence of web page navigation on at least one of the other target web pages.

2. The method of claim 1 wherein said communicating comprises
communicating directly or indirectly between the first target web page and at least one of the other target web pages.

3. The method of claim 1 wherein said communicating comprises
a web browser application intercepting a programmatic or user action on a first target web page and said web browser causing navigation to occur on at least one of the other target web pages hosted by the web browser application.

4. The method of claim 1 wherein said communicating comprises
a web browser application intercepting a programmatic or user action on a first target web page and said browser communicating with at least one other web browser application causing navigation to occur on at least one of the target web pages hosted by said other browser applications.

5. The method of claim 1 further comprising
identifying each target by a unique target identifier.

6. The method of claim 1 further comprising
defining a centrally managed target set account on a target set server;
logging-in to the target set account from each device to be included in the target set thereby creating an entry for each such logged-in device, each entry including at least an identifier for each device and connection information for each device; and
causing, using information stored in the entries in the target set server, displays on any of the devices identified in the target set entries to display said occurrence of web page navigation.

7. The method of claim 6 wherein creating the identifier for a device comprises
creating a unique secure identifier for each device of the target set.

8. The method of claim 6 wherein the entry for each logged-in device further includes a short, easily read, name identification for the device.

9. The method of claim 7 further comprising
storing the unique identifier for a device as a cookie on the device.

10. The method of claim 6 wherein
the entry for each device comprises a connection identification identifying a communications channel between the target set server and the device, and
establishing said communications channel between said target set server and said Web browser instance on which a target is running.

11. The method of claim 10 further comprising
interrogating the target set server by a device by passing its identification identifier to the target set server; and
receiving in response, a list of names and identifiers for the targets belonging to the interrogating target set of the interrogating server.

12. The method of claim 11 further comprising
using the target set server as an intermediary for communicating between any two devices in the target set.

13. The method of claim 6 further comprising
identifying a target device browser instance using a drop-down menu at the interrogating device.

14. The method of claim 6 further comprising
identifying a target device by embedding the target device browser instance identification in a hyperlink at the interrogating device.

15. The method of claim 6 further comprising
identifying a target device browser instance by clicking on a button identifying the target device browser instance at the interrogating device.

16. A system for operating at least one web browser application, collectively displaying at least two computer generated target web pages, comprising
a communication arrangement providing communications between a communication source comprising at least one of a first target web page and its first web browser application, to at least one other of said target web pages; and
said communications causing an action on said first target web page to affect the occurrence of web page navigation on at least one of the other target web pages.

17. The system of claim 16 wherein said communications arrangement comprises
elements for communicating directly or indirectly between the first target web page and at least one of the other target web pages.

18. The system of claim 16 wherein said communications arrangement comprises
a web browser application intercepting a programmatic or user action on a first target web page and said web browser causing navigation to occur on at least one of the other target web pages hosted by the web browser application.

19. The system of claim 16 wherein said communications arrangement comprises
a web browser application intercepting a programmatic or user action on a first target web page and said browser communicating with at least one other web browser application causing navigation to occur on at least one of the target web pages hosted by said other browser applications.

20. The system of claim 16 further comprising
said communications arrangement identifying each target by a unique target identifier.

21. The system of claim 16 further comprising
a plurality of user devices,
a target set server,
the target set server having a target set database having an entry for each device logged-in thereto,
each entry having at least a unique secure identifier for each logged-in device, and connection information for connecting the target set server to the identified logged-in device, and
each entry further having an identification of a browser for each device running two or more browser instances.

22. A system for operating at least one web browser application, collectively displaying at least two computer generated target web pages, comprising
means for communicating between a communication source comprising at least one of a first target web page and its first web browser application, to at least one other of said target web pages; and
means for causing an action on said first target web page to affect the occurrence of web page navigation on at least one of the other target web pages.

23. The system of claim 22 wherein said means for communicating comprises
means for communicating directly or indirectly between the first target web page and at least one of the other target web pages.

24. The system of claim 22 wherein said means for communicating comprises
means for intercepting, through a web browser application, a programmatic or user action on a first web target web page, and
means for communicating, through the browser, with at least one other web browser application, for causing navigation to occur on at least one of the target web pages hosted by the other browser applications.

25. The system of claim 22 wherein said means for communicating comprises
means for intercepting, through a web browser application, a programmatic or user action on a first target webpage, and
means for causing, through said web browser, navigation to occur on at least one of the other target web pages hosted by the web browser application.

26. The system of claim 16 further comprising
means for identifying each target by a unique target identifier.

27. A system for interacting with a computer generated webpage comprising
means for defining a centrally managed target set account on a target set server;
means for logging-in to the target set account from each device to be included in the target set thereby creating an entry for each such logged-in device, each entry including at least an identifier for each device and connection information for each device; and
means for enabling, using information stored in the entries in the target set server, displays on any of the devices identified in the target set entries.

28. The system of claim 27 wherein creating the identifier for a device comprises
means for creating a unique secure identifier for each device of the target set.

29. The system of claim 27 wherein
the entry for each device comprises means for identifying a communications channel between the target set server and the device, and
means for establishing said communications channel between said target set server and said Web browser instance on which a target is running.

30. The system of claim 27 further comprising
means for interrogating the target set server by a device by passing its identification identifier to the target set server; and
means for receiving in response, a list of names and identifiers for the targets belonging to the interrogating target set of the interrogating server.
